(19) United States
(12) Patent Application Publication
(10) Pub. No.: US 2007/0026156 A1
(43) Pub. Date: Feb. 1, 2007

(54) Coating method and apparatus

(75) Inventors: Toshihiro Mandai, Odawara-shi (JP); Satoshi Nagano, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/496,472

(22) Filed: Aug. 1, 2006

(30) Foreign Application Priority Data
Aug. 1, 2005 (JP) NO.2005-223251

(51) Int. Cl. B05D 3/00; B05D 7/00; B05D 1/36; B05C 13/02; B05C 3/12; B05C 3/02

(52) U.S. Cl. 427/402; 427/299; 427/372.2; 427/356; 118/420; 118/66; 118/58; 118/410

(57) ABSTRACT

The present invention provides a coating method for coating one or more layers on a surface of a continuously moving belt-like substrate. The method includes a cleaning step of maintaining a cleanliness level of class 1000 or less near the substrate before a coating step. According to the present invention, any adhesion of extraneous material, dirt, dust and the like to a continuously moving web or coating layer surface can be prevented to reduce coating defects such as streak development.

### BACKGROUND OF THE INVENTION

1. Field of the Invention

The present invention relates to a coating method and apparatus, in particular, a coating method and apparatus to apply thin and precise multi-layers of magnetic recording media, photographic sensitive materials, electronic materials, batteries by coating, optical films for antireflection and the like, polishing tape, information recording paper and the like by sequentially applying a coating solution to a continuously moving substrate.

2. Description of the Related Art

Conventionally, a coating solution can be applied to a continuously moving substrate (web) by various coating methods including roll coating method, gravure coating method, roll coating with doctor method, slot die coating method, and slide coating method. In particular, in order to apply a magnetic coating solution to a magnetic tape, for example an extrusion coating method or a tensioned web coating method in which a continuously moving web is pressed over a distal end of a slot die so that a coating solution extruded from the distal end of the slot die is applied to the tensioned web is used because a thin and precise coating can be achieved at a high-speed.

In the magnetic recording field, a medium developed for recording more information with higher recording density is required due to the digitization of broadcast equipment and the wide use of personal computers and other information related equipment. To increase the density, a magnetic layer is getting thinner having a thickness of several 100 nm or less, and an area for 1 bit in the layer is getting smaller. Unfortunately this increases a possibility to cause the electromagnetic conversion property of recording signals to be lowered by a minute defect, which results in an error in reading and writing. Thus, in a process to apply a magnetic coating solution, it is important to reduce any adhesion of dirt, fine pin holes, and streak developments on the order of several μm.

Currently, a magnetic tape has a surface for recording which is provided with two layers of a non-magnetic lower layer and a magnetic upper layer, and this configuration enables the magnetic layer to be thinner and the recording density to be higher in applying a magnetic coating solution. For such multilayer coating, a wet on dry method in which a lower layer is first applied and then after drying and solidification of the lower layer an upper layer is applied, or a simultaneous multilayer coating method in which a non-magnetic lower layer and a magnetic upper layer are simultaneously applied through an integrated slot die is preferably used. However, in the simultaneous multilayer coating method, when a magnetic layer has a thickness of 100 nm or less, the interface between the non-magnetic layer and the magnetic layer is unstable, and microscopically the thickness of the magnetic layer becomes significantly uneven. So, for a magnetic layer having a thickness of 100 nm or less, the wet on dry method is more preferable.

In the wet on dry method, because each layer is separately coated, the coating thickness at one time is much thinner than that in the simultaneous multilayer coating. Thus, when a magnetic coating solution is coated in a wet on dry application using a slot die, the thinner the coated layer becomes, the smaller a gap between a web and a distal end of the slot die becomes. In such a condition, there is a problem that, if dirt is carried with the web, the dirt is trapped between the web and the distal end of the slot die, which causes a streak development.

To solve the above problem, conventionally a web has been cleaned in advance (e.g. dust collection with adhesive roll, air knife, or ultrasonic wave). For example, Japanese Patent Application Laid-Open No. 2002-79200 discloses a dust collecting apparatus to clean a web using a wet method. According to the patent, the disclosed apparatus removes the extraneous material, dirt, dust, and the like which adhered to a web surface without scratching the web surface or damaging the web surface.

Also, Japanese Examine Application Publication No. 6-077712 discloses a slot die for multilayer coating with a simultaneous multilayer coating method. According to the patent, any streak development in coating can be prevented.

### SUMMARY OF THE INVENTION

However, in the multilayer coating such as sequential coating, unlike the simultaneous multilayer coating, a plurality of coating steps are performed at predetermined time intervals. As a result, after a first layer is applied and dried, some extraneous materials or dirt often adhere to the coating layer surface of a web while the web is conveyed before a second layer is coated. The extraneous materials or dirt are trapped between the web and a distal end of a slot die in coating a second layer, which causes a problem of a streak development in coating. Especially, when the total wet thickness of the applied coating layers for the second and later layers is 5 μm or less, the development is commonly observed.

The dust collecting apparatus disclosed in Japanese Patent Application Laid-Open No. 2002-79200 is not controlled to prevent the adhesion of extraneous material or dirt after a dust collection before coating. This often causes a streak development as described above even in coating a first layer on a web. Moreover, there is another problem that a larger size of apparatus is required to improve cleanliness level throughout all the processes including coating and drying, which costs more.

The present invention is made in view of the above mentioned problems, and one object of the present invention is to provide a coating method and apparatus which prevents any adhesion of extraneous material, dirt, dust and the like to a continuously moving web or coating layer surface and reduces coating defects such as streak development.

To accomplish the above objects, a first aspect of the present invention provides a coating method for coating one or more layers on a surface of a continuously moving belt-like substrate, wherein the method comprises a cleaning step of maintaining a cleanliness level of class 1000 or less near the substrate before a coating step.

The present invention provides a cleaning step of maintaining a cleanliness level of class 1000 or less before a coating step. This prevents any trapping of extraneous material, dirt, dust and the like, in coating a first layer to a substrate or in coating a second and later layers on the coating surface of the first layer, between a coating device (e.g. slot die) and the substrate (in coating a first layer), or between a coating device and a coating layer surface (in coating a second and later layers). The extraneous material, dirt, dust and the like which adhered to a substrate or coating layer surface can be removed. Therefore, any trapping of extraneous material, dirt, dust and the like between a substrate or coating layer surface and a coating device which causes coating defects such as streak development can be prevented.

The cleanliness level near a substrate in the first aspect is defined as a number of dust particles having a diameter of 0.5 μm in 1 ft³ (2.83×10⁻² m³) which is measured by a dust counter having an intake port closely disposed to a substrate or coating layer surface. A cleanliness level of class 100 or less is preferably maintained. The cleaning step may be performed as a separate step between a coating and drying step and a subsequent coating step, or may be preformed as one combined process for both drying and cleaning.

A second aspect of the present invention provides the method according to the first aspect, wherein the coating is sequential coating for sequentially coating two or more coating layers, and the cleaning step is performed at least before a coating step of coating a second or later layer among a plurality of coating steps for the sequential coating.

According to the second aspect, particularly when multilayers are coated by sequential coating, any trapping of extraneous material, dirt, dust and the like between a coating device and a coating layer surface (in coating a second and later layers) can be prevented. This reduces coating defects such as streak development.

A third aspect of the present invention provides the method according to the second aspect, wherein the total wet thickness of the coating layers for the second and later layers is 5 μm or less.

Particularly when the total wet thickness of the coatings for the second and later layers is small such as 5 μm or less, any trapping of extraneous material, dirt, dust and the like between a coating device and a coating layer surface tends to cause coating defects such as streak development. According to the third aspect, even when such thin layers are coated, any trapping of extraneous material can be prevented, which is an advantageous effect of the present invention.

A fourth aspect of the present invention provides the method according to the second or third aspect, wherein, in the sequential coating, the second and later layers are coated without winding up the first layer after the first layer is coated and dried.

In multilayer coating for successively coating a second and later layers after coating of a first layer without winding up the first layer, coating defects such as streak development are more likely to occur compared to the case in which a second layer is coated again after a first layer is coated and wound up once. According to the fourth aspect, even in such multilayer coating for successively coating multilayers, any trapping of extraneous material, dirt, dust and the like between a coating device and a coating layer surface (in coating a second and later layers) can be prevented, which avoids coating defects such as streak development.

A fifth aspect of the present invention provides the method according to any one of second to fourth aspects, wherein, in the cleaning step, 70% or more of the substrate along its longitudinal direction is maintained in a cleanliness level of class 1000 or less between one coating and the next coating.

The fifth aspect defines an extent of a substrate to be maintained at a cleanliness level of class 1000 or less to effectively prevent any trapping of extraneous material, dirt, dust and the like on a substrate or coating layer surface between one coating and the next coating.

A sixth aspect of the present invention provides the method according to any one of second to fifth aspects, wherein, in the plurality of coating steps for the sequential coating, at least a coater which coats the second or later layer is a tensioned-web-over-slot die coater which presses the substrate over a distal end of a slot die for coating.

In such a tensioned-web-over-slot die coater, the space between a substrate (or coating surface) and a slot die is so small that a thin film coating can be achieved which requires high accuracy, but at the same time, coating defects such as streak development by for example extraneous materials are likely to occur. So, the present invention provides an advantageous effect in using a tensioned-web-over-slot die coater.

A seventh aspect of the present invention provides the method according to any one of first to sixth aspects, wherein the method comprises a rinsing step of rinsing extraneous materials adhered to the substrate surface, before the cleaning step which is performed before the coating step of coating the first layer.

The seventh aspect further provides a rinsing step of rinsing the substrate before the cleaning step because it is hard to remove the extraneous material, dirt, dust and the like adhered to the substrate only by the cleaning step. This prevents coating defects such as streak development in coating the first layer to the substrate.

The rinsing method in the seventh aspect may be preferably, but not limited to, a method to press a substrate to nonwoven fabrics or blade, a method to remove extraneous materials from a substrate surface by blowing rinsing air at a high-speed, a method to press nonwoven fabrics or blade to a solvent which is coated and still remained before drying, a method to remove extraneous materials from a moving substrate surface by contacting an adhesive roll with the moving substrate surface, or a method to use the above methods in combination.

An eighth aspect of the present invention provides the method according to any one of second to seventh aspects, wherein the sequential coating is two-layer coating, and a coating solution for the first layer is a non-magnetic coating solution, and a coating solution for the second layer is a magnetic coating solution.

In manufacturing a magnetic recording medium with improved recording density by thinning a magnetic layer thereof, coating defects such as streak development caused by extraneous materials result in performance degradation of products. In this situation, the eighth aspect of the present invention provides an advantageous effect.

In order to achieve the above object, a ninth aspect of the present invention provides a coating apparatus for sequentially coating two or more layers to a surface of a continuously moving belt-like substrate by successively coating a second and later layers after coating and drying a first layer without winding up the first layer, wherein the apparatus comprises: a plurality of coaters which sequentially coats two or more layers to the substrate; a drying device which is mounted downstream of each of the plurality of coaters to dry the coated layers formed on the substrate; and a cleaning device which is disposed upstream of at least the coaters that coats the second and later layers among the plurality of coaters to maintain a cleanliness level of class 1000 or less near the substrate.

The ninth aspect is a coating apparatus configured according to the present invention. According to the ninth aspect, coating defects such as streak development which are caused by trapping of extraneous material, dirt and the like between a substrate or coating layer surface and a coating device can be prevented.

In the ninth aspect, the cleaning device may be separately provided between a coating and drying device and a subsequent coating device, or may be provided as an integral device for drying and cleaning.

A tenth aspect of the present invention provides the coating apparatus according to the ninth aspect, wherein the apparatus further comprises a rinsing device which rinses extraneous materials adhered to the substrate surface, the rinsing device being disposed upstream of the cleaning device which is disposed upstream of a coater that coats the first layer in the sequential coating.

According to the tenth aspect, because the removal of extraneous material, dirt, dust and the like which is hard to remove only by the cleaning device can be achieved before coating, coating defects such as streak development can be prevented in coating the first layer to the substrate.

An eleventh aspect of the present invention provides the coating apparatus according to the ninth or tenth aspect, wherein the cleaning device comprises: a casing which annularly surrounds the substrate; an air supplying device which supplies cleaned air into the casing; a measuring device which measures the number of dust particles in the casing; and a controlling device which controls the amount of air to supply or the amount of air to circulate by the air supplying device based on the result of the measurement by the measuring device.

The eleventh aspect defines a specific configuration of the cleaning device. According to the eleventh aspect, any coating defects such as streak development caused by extraneous materials adhered to the substrate or coating layer surface can be reliably prevented because the cleanliness level of class 1000 or less near the substrate is monitored and maintained. Also, the casing reduces the space to control the cleanliness level thereof, which allows the cleanliness level to be maintained at low cost with high efficiency.

The cleaned air in the eleventh aspect means the air of a high cleanliness level from which extraneous materials, dust and the like are removed by air purifying devices such as a dust filter, an air filter for extraneous materials, or a dust collecting apparatus using static electricity.

A twelfth aspect of the present invention provides the coating apparatus according to any one of the ninth to eleventh aspects, wherein the total wet thickness of the coating layers for the second and later layers is 5 μm or less.

Particularly when the total wet thickness of the coatings for the second and later layers is 5 μm or less, any trapping of extraneous material, dirt, dust and the like between a coating device and a coating layer surface tends to cause coating defects such as streak development. According to the twelfth aspect, the present invention provides an advantage to such a thin layer coating because any trapping of extraneous material can be prevented.

A thirteenth aspect of the present invention provides the coating apparatus according to any one of the ninth to twelfth aspects, wherein, in the plurality of coaters for sequential coating, at least a coater which coats the second or later layer is a tensioned-web-over-slot die coater which presses the substrate over a distal end of a slot die for coating.

In such a tensioned-web-over-slot die coater, the space between a substrate (or coating surface) and a slot die is so small that a thin film coating can be achieved which requires high accuracy, but at the same time, coating defects such as streak development by extraneous materials for example are likely to occur. So, the present invention provides an advantage in using a tensioned-web-over-slot die coater.

A fourteenth aspect of the present invention provides the coating apparatus according to any one of the ninth to thirteenth aspects, wherein the sequential coating is two-layer coating, and a coating solution for the first layer is a non-magnetic coating solution, and a coating solution for the second layer is a magnetic coating solution.

According to the fourteenth aspect, the present invention provides a significant advantage because, in manufacturing a magnetic recording medium with improved recording density by thinning a magnetic layer thereof, coating defects such as streak development caused by extraneous materials result in performance degradation of products.

As described above, according to the present invention, any adhesion of extraneous material, dirt, dust and the like to a continuously moving web or coating layer surface can be prevented to reduce coating defects such as streak development.

### BRIEF DESCRIPTION OF THE DRAWINGS

FIG. 1 is a diagram to show the entire configuration of a coating apparatus of an embodiment according to the present invention;

FIG. 2 is a schematic cross sectional diagram to show a coating section of an embodiment according to the present invention;

FIG. 3 is a schematic diagram to show the cross section of an edge surface of a slot die of an embodiment according to the present invention; and

FIG. 4 is a schematic cross sectional diagram to show a cleaning section of an embodiment according to the present invention.

### DETAILED DESCRIPTION OF THE PREFERRED EMBODIMENTS

Now, preferred embodiments of a coating method and apparatus according to the present invention will be described below in detail with reference to the accompanying drawings.

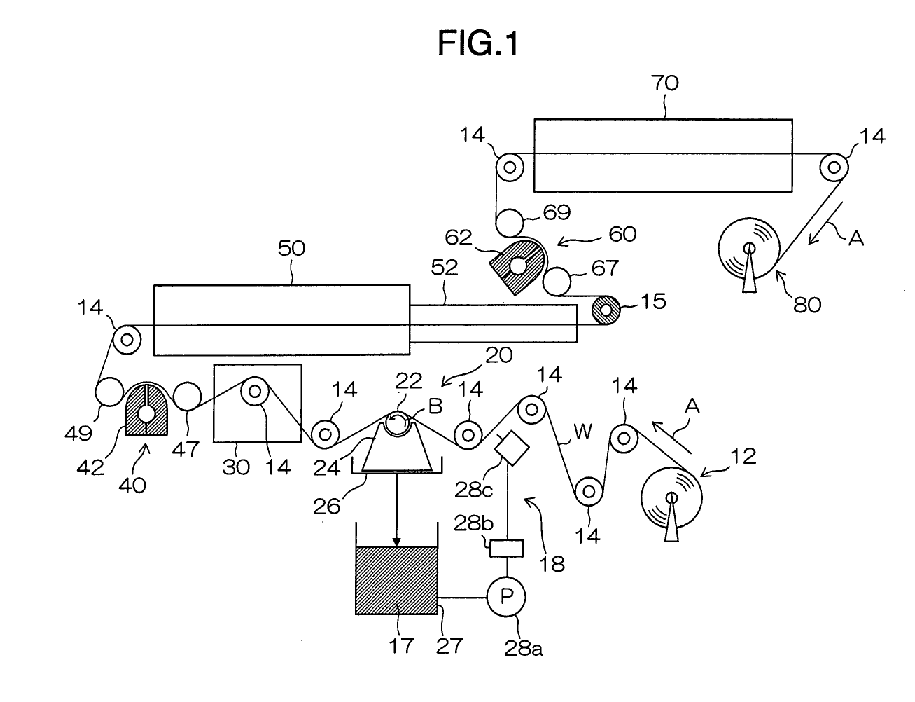

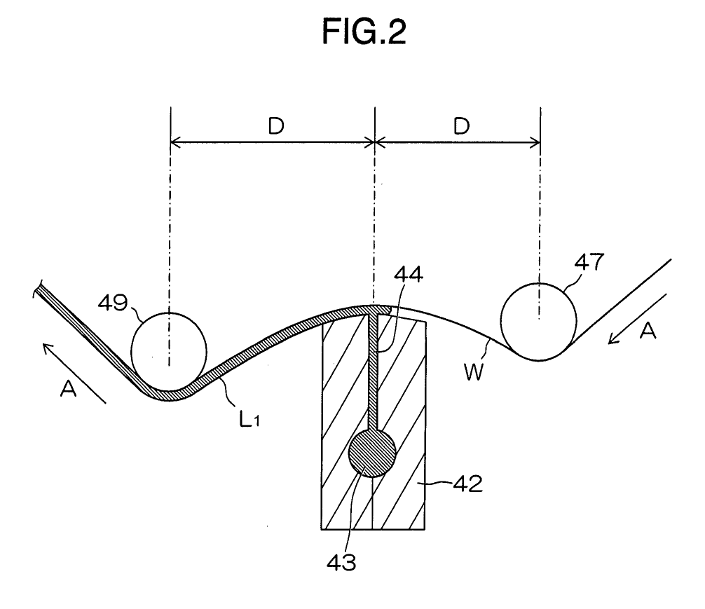

In this embodiment, two layers, a non-magnetic coating solution as a first layer and a magnetic coating solution as a second layer, are sequentially coated to a continuously moving belt-like substrate (hereinafter, referred to as a web W). FIG. 1 is a diagram to show the entire configuration of a coating apparatus 10 according to the present invention. FIG. 2 is a schematic cross sectional diagram to show the configuration of a coating section 40. The direction in which the web W moves is shown by an arrow A.

As shown in FIG. 1, the coating apparatus 10 mainly comprises: a feeding apparatus 12 for feeding the web W which has been wound up into a roll; guide rollers 14 for guiding the moving of the web W; a rinsing section 20 for rinsing the extraneous materials adhered to a surface of the web W; a first coating section 40 for applying a first layer (hereinafter, referred to as a non-magnetic layer) to the web W; a first drying section 50 for drying the non-magnetic layer; a cleaning section 52 for preventing adhesion of extraneous material, dirt, dust and the like to the surface of the non-magnetic layer; a second coating section 60 for applying a second layer (hereinafter, referred to as a magnetic layer); a second drying section 70; and a winding apparatus 80. The rinsing section 20 will be explained below.

The web W in this embodiment may be, but not limited to, a plastic film such as polyethylene terephthalate, polyethylene-2,6-naphthalate, cellulose di acetate, cellulose tri acetate, cellulose acetate propionate, polyvinyl chloride, polyvinylidene chloride, polycarbonate, polyimide, and polyamide, paper, laminated paper, and metal foil. The web W, typically but not limited to, has a width of 0.1 to 3 m, a length of 1000 to 100000 m, and a thickness of 0.5 to 100 μm.

The guide rollers 14 are arranged at each predetermined position for guiding the moving of the web W.

The first coating section 40, as shown in FIG. 2, mainly includes a slot die 42 for applying a coating solution L₁ as a non-magnetic layer to the web W, and pressure rollers 47, 49 facing to the surface of the web which is opposite to the coating surface of the web. The second coating section 60 for applying a magnetic layer is configured in the same way as described for the first coating section 40, so detailed explanation of the second coating section 60 will be omitted.

The slot die 42 mainly includes a solution supplying system (not shown), a pocket 43, and a slot 44.

As shown in FIG. 2, in the slot die 42, a coating solution L₁ is fed by an external solution supplying system (not shown) (e.g. a feeding pump) to flow from the pocket 43 through the slot 44 to be extruded toward the web W (upward in FIG. 2), so that the laminar flow of coating solution L₁ is discharged at a uniform flow rate and uniform hydraulic distribution from an edge surface of the die 42. The discharged coating solution L₁ is successively applied to the moving surface of the web W.

A distance D between the pressure rollers 47, 49 and the slot die 42 is preferably set to be on the order of 50 to 300 mm. The pressure rollers 47, 49 are preferably movably provided to conveniently adjust an angle of incidence or an angle of emergence of the web W to the slot die 42 depending on coating conditions. When a web with low rigidity is used, the pressure rollers 47, 49 may be expander rolls, crown rolls or concave rolls to prevent tangles and wrinkles of the web.

The coating speed may be in, but not limited to, a wide range of 30 to 1500 m/min. The web W is moved under an applied tension of 5 to 50 kgf (49 to 490 N) per 1 m width of the web, in order to stabilize the moving of the web W and uniformly press the web W to the slot die 42 at the first coating section 40, and preferably the tension is conveniently adjusted depending on the coating conditions.

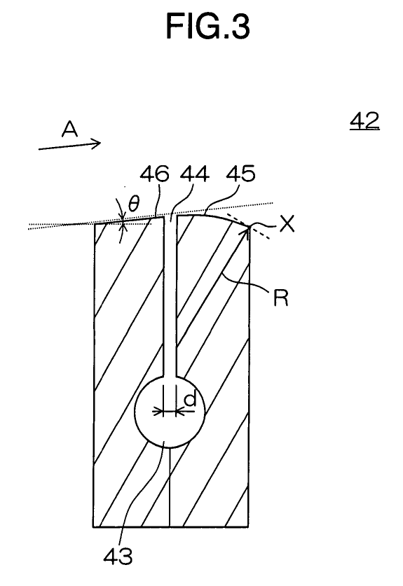

Next, referring to FIG. 3, a preferable shape for the edge surface of the slot die 42 will be explained. FIG. 3 is a schematic diagram to show the cross section of an edge surface of the slot die 42. The edge surface of the slot die 42 facing to the moving surface of the web W includes a downstream edge surface 45 and an upstream edge surface 46, these surfaces being separated by a slot 44 having a width d.

The upstream edge surface 46 is planar and forms an angle θ to the angle of incidence of the web W. The downstream edge surface 45 is convex toward the web W and has an arc shape of a radius of curvature R so that the tangent angle at the downstream edge X is equal to the angle of emergence of the web W. The widths d of the slots 44, 64 are preferably 0.05 to 2 mm. The angles θ at the upstream edge surfaces 46, 66 of the slot dies 42, 62 are preferably 5 to 45 degrees. The downstream edge surfaces 45, 65 of the slot dies 42, 62 preferably have a radius of curvature R of 1 to 20 mm, which is conveniently designed depending on the type of a web, a coating speed, coating solution properties, and a coating thickness.

The upstream edge surface 46 may have any shape without particular limitation and may be for example a combination of a plurality of planes or a curved surface having a certain curvature. In this way, a shape of the edge surface, a slot width, and a slot length are adjusted depending on the coating conditions. The edge surface is preferably made of a rigid material.

In this coating method, the web W is lifted from the downstream edge surfaces 45, 65 by a distance of about twice the thickness of the wet coating thickness. For example, when the wet coating thickness is 5 μm, the distance between the downstream edge surface and the web W is about 10 μm. That is, the thinner wet coating thickness reduces the distance between the web W and the downstream edge surface 45, 65, and even minimum dirt that adheres to a surface of the web W tends to cause a streak development.

The first drying section 50 is an apparatus to dry the non-magnetic layer which was applied in the first coating section 40, and the second drying section 70 is an apparatus to dry the magnetic layer which was applied in the second coating section 60 (the structure of the second drying section 70 is similar to that of the first drying section 50, so the second drying section 70 will not be explained or illustrated herein).

The first drying section 50, which is not particularly illustrated herein, is mainly configured to include a heated air supply section to supply heated air to the applied layer on the web W, an exhausting duct to exhaust the heated air which flows through the drying section 50, and a dust collecting section (e.g. air filter) to improve the cleanliness level inside of the drying section 50.

This configuration enables the applied layer on the web W to be heat dried by the heated air while being conveyed by means of the guide rollers 14, 14 . . .

Any known drying apparatus may be used, including a roller conveyer dryer in which a non-coating surface of a web is supported by a roll and air is blown from an air nozzle to a coating surface to dry it, a non-contact air floating dryer in which air is blown to both a non-coating surface and a coating surface of a web to dry the web in a state of the web being floating, that is, being not in contact with a roll, and a helical movement type of drying which is one of non-contact dryers and effectively uses a space and effectively dries a web. The first drying section 50 preferably has both drying function and rinsing function. In this case, the rinsing method is preferably performed in the same way as in the cleaning section which will be explained below, so that a cleanliness level of class 1000 or less near a web in a drying apparatus can be maintained.

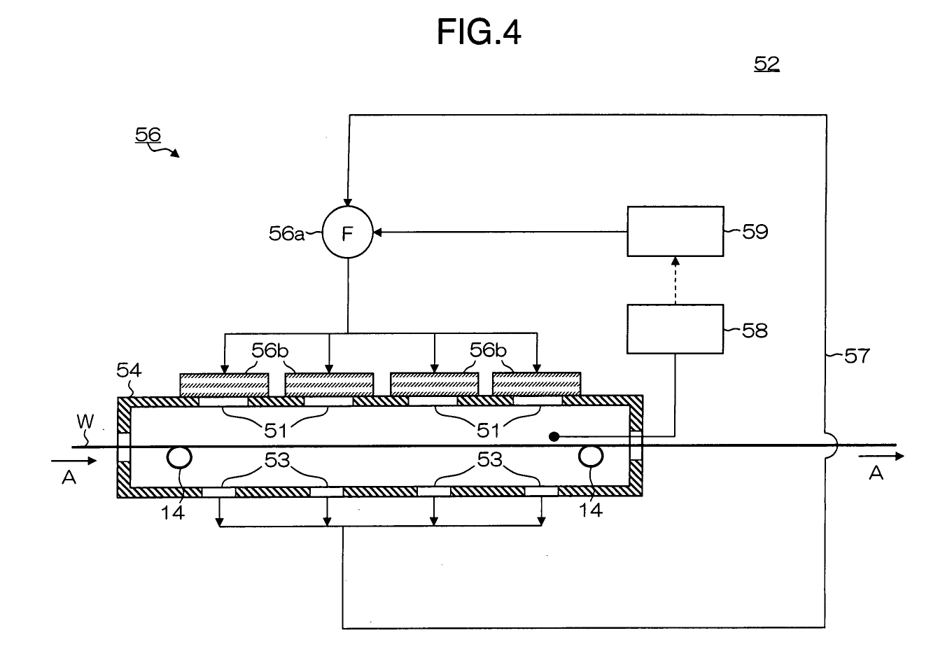

The cleaning section 52 is an apparatus to supply/circulate cleaned air to maintain a high cleanliness level near a web. FIG. 4 is a schematic cross sectional diagram to show a configuration of the cleaning section 52.

The cleaning section 52 generally comprises a casing 54 to annularly surround the web W; an air supplying section 56 to supply cleaned air into the casing 54; a measuring section 58 to measure the number of dust particles in the casing 54 near the web W; and a controlling section 59 to control the amount of air to supply or the amount of air to circulate by the air supplying section 56 based on the measurement signal by the measuring section 58.

The casing 54 includes, as shown in FIG. 4, air inlets 51 to supply cleaned air and air outlets 53 which are formed in the surface of the casing opposite to the coating surface of a web W. The cleaned air is supplied through the air inlets 51 into the casing 54 and exhausted through the air outlets 53.

The air supplying section 56 may be preferably a fan filter unit including an air supply fan 56a which supplies air into the casing 54 and a filter 56b which removes extraneous materials in the supplied air.

In the above configuration, the air from the air supply fan 56a flows through the filter 56b to be cleaned by removing extraneous materials such as extraneous materials and dust, and is supplied through the air inlets 51 into the casing 54. The circulation of the cleaned air improves the cleanliness level in the casing 54.

The air flows through the casing 54 and is exhausted from the air outlets 53 to return to the air supply fan 56a via a duct 57. The returned air is, as described above, supplied into the casing 54 as a cleaned air after the removal of extraneous materials by the filter 56b. This circulation maintains the cleanliness level of class 1000 or less near a web W which moves inside of the casing 54.

In order to remove extraneous materials in the air, in addition to a filter, a neutralization apparatus of a static eliminator (e.g. blower for elimination of static electricity) may be provided as needed to prevent any adhesion of dust to a web W, and any apparatus which effectively removes dust from a web W may be provided without particular limitation.

In this embodiment, a circulation system is explained in which the cleaned air is almost perfectly recycled for use as shown in FIG. 4 because the cleaning section is provided after the coating layer is dried at the first drying section 50, but other system may be used. For example, in a wet on wet application in which a sequent coating is applied onto a dryish coated layer, that is, when a coated layer is not fully dried and a solvent which rapidly evaporates is used (when drying and rinsing should be simultaneously performed), the almost complete recycling and circulating of the exhausted air as shown in FIG. 4 may cause accumulation of the solvent concentration which has evaporated in the air. To avoid the accumulation, only a part of the air exhausted from the casing 54 may be combined with new outside air from the air supply fan 56a to be recycled for use (the remainder will be discarded to an exhaust duct having an exhaust fan). This avoids the residue or accumulation of the evaporated solvent in the cleaned air, and also improves the cleanliness level inside the casing 54. Alternatively, instead of recycling of the air which once flew through the casing 54, new cleaned air may be taken from an air supply duct into the casing 54 to flow in one direction, and is exhausted through an exhaust fan into an exhaust duct.

The measuring section 58 measures the number of dust particles near a web W in the casing 54. The measuring section 58 includes a signal conversion section for converting measurement signals into electrical signals, where measurement signals which were converted into the electrical signals by the signal conversion section are output to the controlling section 59. A plurality of measuring points may be located to reduce any differences of cleanliness levels due to different positions in the casing 54 and maintain a uniform cleanliness level.

The controlling section 59 controls (feedback control) the amount of air to supply through the air supply fan 56a based on the measurement signals to elevate a cleanliness level in the casing 54 to a predetermined set point. In this embodiment, a cleanliness level in the casing 54 can be controlled by changing the amount of cleaned air to supply or circulate, the times of air circulations, and the like. The supply or circulation of cleaned air may be continuous or intermittent.

In this way, the cleanliness level near a web W in the casing 54 is monitored to control the amount of cleaned air to supply or circulate, thereby an elevated cleanliness level can be maintained.

Between one coating and the next coating, 70% or more of the web W along its longitudinal direction is preferably maintained in an elevated cleanliness level by the cleaning section 52. Also, the maintenance of the cleanliness level of class 1000 or less reliably prevents any adhesion of extraneous material, dust, dirt and the like to a coated layer surface.

The elongated annular casing 54 which has a reduced volume and corresponds to the shape of the passage to convey a web W does not drop the wind speed of cleaned air in the casing 54, and eliminates any dead zone where there is no flow of cleaned air. This enables an efficient elimination of dust for a web W with a small amount of cleaned air, and a reduction of total air amount to be used in manufacturing.

In addition to the above, a static pressure sensor and a static pressure adjusting apparatus may be separately provided to control the internal static pressure of the casing 54 to be higher than normal atmospheric pressure or external static pressure of the casing 54. This effectively restrains any unclean air from flowing into the casing 54 through openings from outside.

The rinsing section 20 is an apparatus to rinse a surface of a web W. As shown in FIG. 1, the apparatus mainly comprises a precoating apparatus 18 as a coating device for coating a rinsing solvent 17 to a surface of the web W, a rod member 22 which is disposed downstream of the precoating apparatus 18 in the moving direction of the web W to scrape most of the rinsing solvent 17 with extraneous materials adhered to the web W before the rinsing solvent 17 is volatilized from the surface of the web W.

The precoating apparatus 18 comprises a tank of rinsing solvent 27 to store the rinsing solvent 17, a pump 28a to squeeze the rinsing solvent 17, a filter 28b to filter the squeezed rinsing solvent 17, a multistage injector nozzle 28c to inject the filtered squeezed rinsing solvent 17 to a surface of a web W. The precoating apparatus 18 is disposed upstream of the rod member 22 to coat the rinsing solvent 17 to a surface of a web W.

The rod member 22 is arranged to contact with the rinsing surface of the web W which is moving between the guide rollers 14, 14 at a certain wrap angle.

The rod member 22 has a diameter of 1 mmφ to 50 mmφ, and at least the surface of the rod member 22 is made of a rigid material such as super hard material (for example, WC-TAC) or ceramic. The rod member 22 is rotatably held by a block 24, and is also coupled to a rotation driving device (not shown) at one end thereof to rotate at a constant speed. The rotation direction B of the rod member 22 may be a forward direction or an opposite direction to the moving direction A of the web W (in FIG. 1, an example in which the rotation direction B is the opposite direction to the moving direction A of the web W is shown). The rotating speed of the rod member 22 is set to be in a range of 10 to 500 rpm.

The guide roller 14 which is disposed downstream of the rod member 22 is provided with a well known height adjusting apparatus (not shown) to adjust the position of the guide roller in a height direction. This allows the wrap angle between the web W and the rod member 22 or the gap between the web W and the downstream side of the block 24 to be conveniently adjusted.

The rinsing solvent 17 of this embodiment may be methyl ethyl ketone, butyl acetate, cyclohexane, toluene, a combination of these, or other compositions based on these rinsing solvents or combination which are added with various binders and have a viscosity of 0.02 Nm⁻²/sec or less, more preferably 0.005 Nm⁻²/sec or less.

In this embodiment, a drying section 30 is preferably provided between the rinsing section 20 and the first coating section 40, a cleanliness level of class 1000 or less being maintained in the drying section 30. This dries and removes the rinsing solvent 17 which has remained on the surface of the web W after rinsing. Also this prevents the web W from being contaminated again by outside air, which prevents coating defects such as streak development in a first layer coating.

Now, a coating method according to the present invention will be explained by way of an example to manufacture a magnetic recording medium with the coating apparatus 10 of FIG. 1 which is configured as described above.

As a first step, a web W is conveyed to the rinsing section 20. The web W at the rinsing section 20 moves along the guidance of the guide rollers 14 to obtain a coating of the rinsing solvent 17 to a surface of the web W by the precoating apparatus 18. Most of the rinsing solvent 17 coated on the web W is scraped off with adhered extraneous materials upstream of the rotating rod member 22. The scraped rinsing solvent 17 is collected in a solvent reservoir 26 below the block 24 to be returned to the tank of rinsing solvent 27. Then, the web W is conveyed to the downstream drying section 30.

In the drying section 30, heated air is blown to the web W to dry and remove the rinsing solvent 17 remained on the surface of the web W. The cleanliness level of class 1000 or less in the drying section 30 is maintained, which prevents any adhesion of dirt and the like to the surfaces of the web W.

Next, at a second step, after rinsing in the previous step, the web W is conveyed generally parallel to the entire edge surface of the slot die 42 in the first coating section 40 under a generally constant tension. Then, a coating solution L₁ for a non-magnetic layer is discharged at a uniform flow rate and uniform hydraulic distribution through the slot die 42 by a solution pump (not shown) or the like to be coated to the moving surface of the web W. Because any extraneous materials adhered to the surface of the web W has been removed in the previous step, coating defects such as streak development do not occur in coating this non-magnetic layer, resulting in a non-magnetic layer with a surface of high quality.

Next, at a third step, after the coating of a non-magnetic layer, the web W is conveyed to the first drying section 50 to be heat dried by heated air. The cleanliness level of class 1000 or less in the first drying section 50 is maintained, which prevents any adhesion of extraneous materials to the coating layers of the web W.

Next, at a fourth step, after the drying in the first drying section 50, the web W is conveyed through a cleaning section 52, where a cleanliness level of class 1000 or less is maintained, to the second coating section 60.

In the cleaning section 52, the measuring section 58 measures the number of dust particles near a web W, and based on the result of measurement, the control section 59 controls the circulation conditions of cleaned air (e.g. times of circulation, an amount of air to supply) to maintain the cleanliness level of class 1000 or less. This maintains an elevated cleanliness level of the surface of the web W to be conveyed to the second coating section 60, and any adhesion of extraneous materials is prevented.

Next, at a fifth step, a magnetic layer having a wet thickness of 5 μm or less is coated onto the non-magnetic layer by the slot die 62 in the second coating section 60. Because most extraneous materials adhered to the surface of the non-magnetic layer has been removed in the previous cleaning section 52, any trapping of extraneous materials between the slot die 62 and the non-magnetic layer surface can be prevented, resulting in a coating of a magnetic layer with a surface of high quality without coating defects such as streak development.

The web W coated with two layers after a process similar to the third step described above is wound up by a winding apparatus 80. In this way, the cleaning section 52 provided after the first coating section 40 reliably prevent any adhesion of extraneous materials to the coating layer surface while the web W is being conveyed. Thus, coating defects such as streak development which are likely to occur particularly in sequential coating of thin layers can be prevented.

In this embodiment, the cleaning section 52 is provided by means of the casing 54, but the entire process before coating or the entire apparatus for coating may be the casing where a cleanliness level of class 1000 or less in the casing is maintained. This configuration also prevents coating defects such as streak development.

The rinsing section 20 is not limited to this embodiment, and other methods listed below may be used.

For example, (1) a method to rinse a web by pressing a nonwoven fabrics or blade to the web surface (see Japanese Patent Application Laid-Open No. 59-150571), (2) a method to remove extraneous materials by blowing highly cleaned air at a high speed to release extraneous materials from a web surface and leading the extraneous materials into an intake port (see Japanese Patent Application Laid-Open No. 10-309553), (3) a method to remove extraneous materials on the surface by contacting an adhesive roll with a moving web (these above three are dry rinsing methods), and (4) a method to clean a web by pressing a nonwoven fabrics or blade to the web surface while a solvent remains on the surface after the coating of the solvent (see Japanese Examine Application Publication No. 5-50419, a wet rinsing method) may be used.

In this way, the present invention prevents any adhesion of extraneous material, dirt, dust and the like to a continuously moving web or a coating layer surface to prevent coating defects such as streak development. The present invention is particularly effective when a slot die coating method is used to apply an upper layer by a wet on dry method (a style of coating by pressing an edge surface of a slot die to a moving web).

In this embodiment, an example to coat two layers was explained, but the present invention may be similarly applied to a multilayer coating for two or more layers. Moreover, in this embodiment, coatings are sequentially performed, but the present invention is not limited to this, and may be applied to a simultaneous multilayer coating.

In this embodiment, an example in which a slot die coating method is used to coat an upper layer by a wet on dry method but the present invention is not limited to this method, and may be similarly applied to other cases using a gravure coating, roll coating, dip coating, slide coating, or slot die coating method.

The present invention may be also applied to a technique to apply a thin and precise coating solution to a continuously moving web to provide functions in manufacturing, not only a magnetic recording medium, but also photographic sensitive materials, electronic materials, batteries by coating, optical films for antireflection and the like, polishing tape, and information recording paper.

### EXAMPLES

Now, Examples to manufacture a magnetic recording media with the coating apparatus 10 will be explained below as examples to which the coating method and apparatus according to the present invention is applied, but the present invention is not limited to these examples.

(Composition of a Coating Solution)

1) Composition of a Non-magnetic Coating Solution

| | | | |
|---|---|---|---|
| non-magnetic powder | α - Fe₂O₃ | 80 | parts by volume |
| BET specific surface | 48 m²/g | | |
| area | | | |
| Average length of major | 0.1 μm | | |
| axis | | | |
| DBP oil absorption | 27 to 38 ml/ | | |
| | 100 g | | |
| pH | 8.0 | | |
| Fe₂O₃ content | 90% or more | | |
| | by mass | | |
| Surface covering | Al₂O₃ | | |
| compound | | | |
| carbon black | | 20 | parts by volume |
| Average primary | 16 μm | | |
| particle diameter | | | |
| DBP oil absorption | 80 ml/100 g | | |
| pH | 8.0 | | |
| BET specific surface | 250 m²/g | | |
| area | | | |
| Volatile loss | 1.5% | | |
| vinyl chloride copolymer | | 10 | parts by volume |
| (MR-110 by ZEON Corpo- | | | |
| ration) | | | |
| polyester polyurethane | | 5 | parts by volume |
| resin (molecular weight | | | |
| 35000) | | | |
| neopentylglycol/ | | | |
| caprolactonepolyol/ | | | |
| MDI = 0.9/2.6/1 | | | |
| —SO₃Na group | 1 × 10⁻⁴ eq/ | | |
| | g included | | |
| stearic acid | | 1 | parts by volume |
| methyl ethyl ketone | | 100 | parts by volume |
| cyclohexanone | | 50 | parts by volume |
| toluene | | 50 | parts by volume |

2) Composition of a Magnetic Coating Solution

| | | | |
|---|---|---|---|
| ferromagnetism powder | Co-substituted | 100 | parts by volume |
| | barium ferrite | | |
| BET specific surface | 35 m²/g | | |
| area | | | |
| Particle diameter | 0.06 μm | | |
| Ratio of largest to | 5 | | |
| smallest dimension | | | |
| vinyl chloride copolymer | | 9 | parts by volume |
| (MR-110 by ZEON Corpo- | | | |
| ration) | | | |
| CrO₂ (particle | | 7 | parts by volume |
| diameter 0.3 μm) | | | |
| polyester polyurethane | | 10 | parts by volume |
| resin | | | |
| neopentylglycol/ | | | |
| caprolactonepolyol/ | | | |
| MDI = 0.9/2.6/1 | | | |
| —SO₃Na group | 1 × 10⁻⁴ eq/ | | |
| | g included | | |
| stearic acid | | 0.5 | parts by volume |
| methyl ethyl ketone | | 70 | parts by volume |
| cyclohexanone | | 60 | parts by volume |
| toluene | | 20 | parts by volume |

(Method for Preparing a Coating Solution)

Two dispersions were prepared by mixing the components for each coating solutions (a non-magnetic coating solution and a magnetic coating solution) in a continuous kneader, and filling the mixtures in a ball mill (ball diameter 0.5 mm) for agitation and dispersion of six hours. Then, to the dispersions were added 3 parts of polyisocyanate by volume. A blended solvent of methyl ethyl ketone and cyclohexanone was conveniently added and agitated to adjust each viscosity. The viscosities were adjusted to 1 to 50 poise (0.1 to 5 Ns/m²) with a Brookfield type viscometer. The non-magnetic coating solution had a viscosity of 10.7 poise (1.07 Ns/m²) and the magnetic coating solution had a viscosity of 3.4 poise (0.34 Ns/m²).

(Coating Method)

In this example, the slot die 42 (62) of Table 1 was used in a coating section (see FIG. 3).

TABLE 1

| | First coating section 40 | Second coating section 60 |
|---|---|---|
| | (slot die 42) | (slot die 62) |
| Upstream edge | Plane with θ = 5 degrees | Plane with θ = 5 degrees |
| surface | | |
| Downstream | Arc having radius of | Arc having radius of |
| edge surface | curvature R = 4 mm | curvature R = 1 mm |
| Slot width d | 0.2 mm | 0.15 mm |

First, after the web W was cleaned before coating, the non-magnetic coating solution above described was coated to a wet thickness of 10 μm on a surface of the web W in the first coating section 40, and dried. Subsequently, the magnetic coating solution was coated as a second layer in the second coating section 60, and dried. The second layer was coated to a wet thickness of 5 μm or less.

(Evaluation Method)

Effects to streak developments in the coating layer surface after two coatings were examined by changing the presence of the cleaning section 52 and the times of circulation of cleaned air in the casing 54 of the cleaning section 52. The streak development was evaluated by visual observations on the coating layer surface after a coating of 1000 m to measure the state of streak development (the number of streaks).

The wet thickness of each coating solution was calculated by dividing the flow rate which was measured with a flow meter located in piping to feed solutions to the slot die 42 (62) by the moving speed of the web W and the coating width.

The cleanliness level was determined by measuring the number of dust particles having a diameter of 0.5 μm in 1 ft³ (2.83×10⁻² m³), by disposing an intake port of the dust particle measuring apparatus 58 close to the web W in the casing 54. The measured results are shown in Table 2.

TABLE 2

| | Coating thickness | | | |
|---|---|---|---|---|
| | of magnetic | Clean | Clean- | Evaluation |
| | coating solution | section | liness | of streak |
| | (wet thickness μm) | 52 | level | development |
| Example 1 | 4.0 | Yes | 889 | Good |
| Example 2 | 3.2 | Yes | 889 | Good |
| Example 3 | 2.5 | Yes | 889 | Good |
| Comparative | 4.2 | No | 3827 | Poor |
| Example 1 | | | | |
| Comparative | 5.3 | No | 3827 | Medium |
| Example 2 | | | | |
| Comparative | 4.2 | Yes | 1432 | Medium |
| Example 3 | | | | |

Good: Number of Developed Streak: 0 to 1,
Medium: Number of Developed Streaks: 2 to 4,
Poor: Number of Developed Streaks: 5 or more

As shown in Examples 1 to 3 of Table 2, good results with 0 to 1 developed streak on the coating layer surface were obtained when there was provided a cleaning section 52 and a cleanliness level of class 800s was maintained near the web.

On the contrary, as shown in Comparative Examples 1, 2, poor results with 2 to 4 or 5 or more developed streaks on the coating layer surface were obtained when there was not provided a cleaning section 52 and a cleanliness level of class 3000 or more was maintained. However, in the Comparative Example 3, 2 to 4 streaks developed on the coating layer surface because the cleanliness level of class 1000 or less was not maintained even if there was provided a cleaning section 52.

The above results shows that when the cleaning section 52 is provided and a cleanliness level of class 1000 or less (preferably, class 100 or less) is maintained in the casing 54, coating defects such as streak development can be prevented, which provides a surface of high quality.

What is claimed is:

1. A coating method for coating one or more layers on a surface of a continuously moving belt-like substrate, the method comprising:
a cleaning step of maintaining a cleanliness level of class 1000 or less near the substrate before a coating step.

2. The coating method according to claim 1, wherein the coating is sequential coating for sequentially coating two or more coating layers, and the cleaning step is performed at least before a coating step of coating a second or later layer among a plurality of coating steps for the sequential coating.

3. The coating method according to claim 2, wherein the total wet thickness of the coating layers for the second and later layers is 5 μm or less.

4. The coating method according to claim 2, wherein, in the sequential coating, the second and later layers are coated without winding up the first layer after the first layer is coated and dried.

5. The coating method according to claim 3, wherein, in the sequential coating, the second and later layers are coated without winding up the first layer after the first layer is coated and dried.

6. The coating method according to claim 2, wherein, in the cleaning step, 70% or more of the substrate along its longitudinal direction is maintained at a cleanliness level of class 1000 or less between one coating and the next coating.

7. The coating method according to claim 5, wherein, in the cleaning step, 70% or more of the substrate along its longitudinal direction is maintained at a cleanliness level of class 1000 or less between one coating and the next coating.

8. The coating method according to claim 2, wherein, in the plurality of coating steps for the sequential coating, at least a coater which coats the second or later layer is a tensioned-web-over-slot die coater which presses the substrate over a distal end of a slot die for coating.

9. The coating method according to claim 7, wherein, in the plurality of coating steps for the sequential coating, at least a coater which coats the second or later layer is a tensioned-web-over-slot die coater which presses the substrate over a distal end of a slot die for coating.

10. The coating method according to claim 1, wherein the method comprises a rinsing step of rinsing extraneous materials adhered to the substrate surface, before the cleaning step which is performed before the coating step of coating the first layer.

11. The coating method according to claim 9, wherein the method comprises a rinsing step of rinsing extraneous materials adhered to the substrate surface, before the cleaning step which is performed before the coating step of coating the first layer.

12. The coating method according to claim 2, wherein the sequential coating is two-layer coating, and a coating solution for the first layer is a non-magnetic coating solution, and a coating solution for the second layer is a magnetic coating solution.

13. The coating method according to claim 11, wherein the sequential coating is two-layer coating, and a coating solution for the first layer is a non-magnetic coating solution, and a coating solution for the second layer is a magnetic coating solution.

14. A coating apparatus for sequentially coating two or more layers to a surface of a continuously moving belt-like substrate by successively coating a second and later layers after coating and drying a first layer without winding up the first layer, the coating apparatus comprising:
a plurality of coaters which sequentially coats two or more layers to the substrate;
a drying device which is mounted downstream of each of the plurality of coaters to dry the coated layers formed on the substrate; and
a cleaning device which is disposed upstream of at least the coaters that coats the second and later layers among the plurality of coaters to maintain a cleanliness level of class 1000 or less near the substrate.

15. The coating apparatus according to claim 14, further comprising a rinsing device which rinses extraneous materials adhered to the substrate surface, the rinsing device being disposed upstream of the cleaning device which is disposed upstream of a coater that coats the first layer in the sequential coating.

16. The coating apparatus according to claim 14, wherein the cleaning device comprises:
a casing which annularly surrounds the substrate;
an air supplying device which supplies cleaned air into the casing;
a measuring device which measures the number of dust particles in the casing; and
a controlling device which controls the amount of air to supply or the amount of air to circulate by the air supplying device based on the result of the measurement by the measuring device.

17. The coating apparatus according to claim 15, wherein the cleaning device comprises:
a casing which annularly surrounds the substrate;
an air supplying device which supplies cleaned air into the casing;
a measuring device which measures the number of dust particles in the casing; and
a controlling device which controls the amount of air to supply or the amount of air to circulate by the air supplying device based on the result of the measurement by the measuring device.

18. The coating apparatus according to claim 14, wherein the total wet thickness of the coating layers for the second and later layers is 5 μm or less.

19. The coating apparatus according to claim 17, wherein the total wet thickness of the coating layers for the second and later layers is 5 μm or less.

20. The coating apparatus according to claim 14, wherein, in the plurality of coaters for sequential coating, at least a coater which coats the second or later layer is a tensioned-web-over-slot die coater which presses the substrate-over a distal end of a slot die for coating.

21. The coating apparatus according to claim 19, wherein, in the plurality of coaters for sequential coating, at least a coater which coats the second or later layer is a tensioned-web-over-slot die coater which presses the substrate over a distal end of a slot die for coating.

22. The coating apparatus according to claim 14, wherein the sequential coating is two-layer coating, and a coating solution for the first layer is a non-magnetic coating solution, and a coating solution for the second layer is a magnetic coating solution.

23. The coating apparatus according to claim 21, wherein the sequential coating is two-layer coating, and a coating solution for the first layer is a non-magnetic coating solution, and a coating solution for the second layer is a magnetic coating solution.
